(19) United States
(12) Patent Application Publication
(10) Pub. No.: US 2026/0260336 A1
(43) Pub. Date: Sep. 3, 2026

(54) IMAGE GENERATION METHOD AND APPARATUS

(71) Applicant: Lenovo (Beijing) Limited, Beijing (CN)

(72) Inventor: Xiaoshuai PENG, Beijing (CN)

(21) Appl. No.: 19/538,384

(22) Filed: Feb. 12, 2026

(30) Foreign Application Priority Data
Feb. 28, 2025 (CN) 202510238040.8

(51) Int. Cl. G06T 7/00; G06T 5/70

(52) U.S. Cl. CPC G06T 7/001; G06T 5/70; G06T 7/0012; G06T 2207/10024; G06T 2207/30004

(57) ABSTRACT

A image generation method includes obtaining a reference image and user-input description information configured to describe image content of a target image to be generated, performing iterative processing on the reference image using an image generation model based on the description information, to obtain one or more intermediate result images each corresponding to one iteration of the iterative processing, determining whether the one or more intermediate result images meet a preset requirement according to a preset detection strategy, and in response to the one or more intermediate result images meeting the preset requirement, continuing to perform the iterative processing using the image generation model based on the one or more intermediate result images until the target image is generated and output for display.

### CROSS-REFERENCE TO RELATED APPLICATION

This application claims priority to Chinese Patent Application No. 202510238040.8, filed on Feb. 28, 2025, the entire content of which is incorporated herein by reference.

### TECHNICAL FIELD

The present disclosure generally relates to the field of image generation technology and, more particularly, to an image generation method and apparatus.

### BACKGROUND

In scenarios where images are generated from text, in order to avoid sensitive content or other non-compliant content in the generated images, the generated images need to be reviewed. If the generated image contains non-compliant content, the image will be deleted, and the user will be informed that the image cannot be generated. However, generating images needs significant processing resources; therefore, discarding an image after generation inevitably leads to a waste of the processing resources consumed in generating the image.

### SUMMARY

In accordance with the disclosure, there is provided a image generation method including obtaining a reference image and user-input description information configured to describe image content of a target image to be generated, performing iterative processing on the reference image using an image generation model based on the description information, to obtain one or more intermediate result images each corresponding to one iteration of the iterative processing, determining whether the one or more intermediate result images meet a preset requirement according to a preset detection strategy, and in response to the one or more intermediate result images meeting the preset requirement, continuing to perform the iterative processing using the image generation model based on the one or more intermediate result images until the target image is generated and output for display.

Also in accordance with the disclosure, there is provided an electronic device including a processor, and a memory storing an application program that, when executed by the processor, causes the electronic device to obtain a reference image and user-input description information configured to describe image content of a target image to be generated, perform iterative processing on the reference image using an image generation model based on the description information, to obtain one or more intermediate result images each corresponding to one iteration of the iterative processing, determine whether the one or more intermediate result images meet a preset requirement according to a preset detection strategy, and in response to the one or more intermediate result images meeting the preset requirement, continue to perform the iterative processing using the image generation model based on the one or more intermediate result images until the target image is generated and output for display.

Also in accordance with the disclosure, there is provided a non-transitory computer-readable storage medium storing an application program that, when executed by a processor, causes an electronic device including the processor to obtain a reference image and user-input description information configured to describe image content of a target image to be generated, perform iterative processing on the reference image using an image generation model based on the description information, to obtain one or more intermediate result images each corresponding to one iteration of the iterative processing, determine whether the one or more intermediate result images meet a preset requirement according to a preset detection strategy, and in response to the one or more intermediate result images meeting the preset requirement, continue to perform the iterative processing using the image generation model based on the one or more intermediate result images until the target image is generated and output for display.

### BRIEF DESCRIPTION OF THE DRAWINGS

The above and other features, advantages, and aspects of the embodiments of the present disclosure will become more apparent in conjunction with the accompanying drawings and the following detailed description. Throughout the drawings, the same or similar reference numerals represent the same or similar elements. It should be understood that the drawings are schematic, and the components and elements might not be drawn to scale.

FIG. 1 is a schematic flowchart of an image generation method consistent with the present disclosure.

FIG. 2 is another schematic flowchart of an image generation method consistent with the present disclosure.

FIG. 3 is another schematic flowchart of an image generation method consistent with the present disclosure.

FIG. 4 schematically shows an implementation logic framework of the image generation method consistent with the present disclosure.

FIG. 5 schematically shows a composition structure of an image generation apparatus consistent with the present disclosure.

FIG. 6 schematically shows a composition architecture of an electronic device consistent with the present disclosure.

### DETAILED DESCRIPTION OF THE EMBODIMENTS

The embodiments of the present disclosure are described below with reference to the accompanying drawings. The terms used in the embodiments of the present disclosure are only used to explain the some embodiments of the present disclosure, and are not intended to limit the scope of the present disclosure. Those skilled in the art will understand that, with the development of technology and the emergence of new scenarios, the technical solutions provided in the embodiments of the present disclosure are also applicable to similar technical problems.

The terms associated with “first,” “second,” etc., in the specification, claims, and the above drawings are used to distinguish similar objects, and do not represent a specific order or sequence. It should be understood that the terms used in this way can be interchanged where appropriate, and this is merely a way of distinguishing objects with the same attributes in the description of the embodiments of the present disclosure. Furthermore, the terms “including” and “comprising,” and any variations thereof, are intended to cover non-exclusive inclusion, so that a process, method, system, product, or device that includes a series of elements is not limited to those elements, but may include other elements not explicitly listed or inherent to these processes, methods, products, or devices.

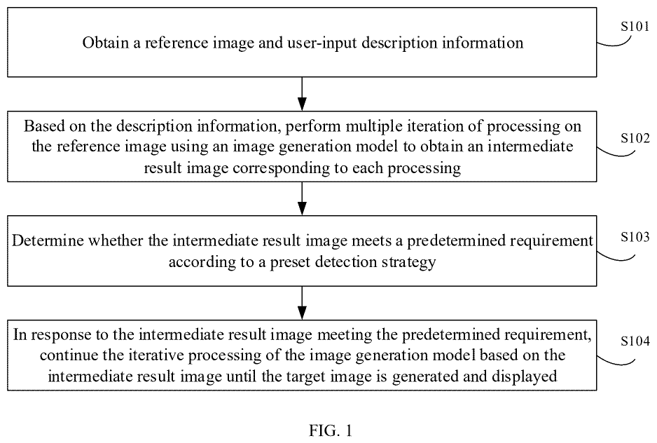

A flowchart of an image generation method consistent with the present disclosure is shown in FIG. 1. The method in this embodiment can be applied to electronic devices, which can be mobile phones, tablet computers, or laptop computers. Of course, the electronic device can also be a device node in a cloud platform or distributed system, or a server, etc., and there is no limitation on this.

The method in the present disclosure includes the following.

At S101, a reference image and user-input description information are obtained.

The reference image is an image that needs to be processed using image generation model to obtain a desired image. For example, the reference image can be a noisy image, or an image that differs from the image the user expects to generate in some aspects, etc., and there is no limitation on this.

The description information is used to describe the image content of a target image to be generated. For example, if the user wants to generate an image of a sleeping cat, the description information can be “Generate an image containing a sleeping cat.”

The description information can be in text form or voice form, without specific limitations.

At S102, based on the description information, multiple iterations of processing are performed (i.e., iterative processing is performed) on the reference image using an image generation model to obtain an intermediate result image corresponding to each processing.

In the present disclosure, the image generation model continuously optimizes the reference image by performing multiple iterative processing, such as multiple iterative denoising processing, to generate a target image that matches the description information.

The image generation model can have different types, and there is no limitation on this.

For example, the image generation model can be a diffusion model, which uses the diffusion model to perform multiple iterative denoising processing on the reference image to generate the target image. Of course, the image generation model can also be a denoising diffusion implicit model, a score-based generation model, or a progressive generative adversarial network model, etc.

In the present disclosure, during the iterative processing of the reference image by the image generation model, the image obtained from each iterative processing is called an intermediate result image. Therefore, the intermediate result image can be any of the images generated by the image generation model before generating a final target image. For example, assuming that the image generation model needs 50 iterations of processing on the reference image to generate the target image, then the image obtained after one iteration of processing the reference image by the image generation model is an intermediate result image, and the 48 images obtained from the 2nd to the 49th iterations of processing the reference image by the image generation model are also intermediate result images.

At S103, whether the intermediate result image meets a preset requirement is determined according to a preset detection strategy.

The detection strategy is a strategy used to determine whether the intermediate result image needs to be detected, or a strategy used to select the intermediate result images that need to be detected.

For example, the detection strategy may include at least one iteration number for image detection, and the intermediate result image obtained after processing the reference image for the corresponding number of iterations is determined as the intermediate result image that needs to be detected.

As another example, the detection strategy may be that every intermediate result image obtained after each iteration needs to be subjected to image detection.

Of course, this detection strategy can have other possibilities, and can be set according to actual needs without specific limitations.

The preset requirements can be set according to actual needs, and the preset requirements will vary in different application scenarios. For example, the preset requirements may include the absence of violent content, sensitive information (such as sensitive characters or sensitive objects, etc.), or other preset content.

It should be noted that S103 is performed during the process of using the image generation model to perform multiple iterations of processing on the reference image, in order to detect whether there are any problems in the intermediate result images obtained from the iterative processing that do not meet the preset requirements.

At S104, in response to the intermediate result image meeting the preset requirement, the iterative processing using the image generation model is continued based on the intermediate result image until the target image is generated and displayed.

The process of using the image generation model to perform multiple iterations of processing on the reference image is as follows: using the image generation model to perform the first iteration of processing on the reference image to obtain an intermediate result image, then using the image generation model to process the intermediate result image obtained from the first iteration to obtain the intermediate result image from the second iteration, then using the image generation model to process the intermediate result image obtained from the second iteration, and so on, until the target image is generated.

Therefore, after the intermediate result image is obtained by performing one iteration of processing on the reference image using the image generation model, in each iteration after the first iteration, the image generation model needs to process the intermediate result image obtained from the current iteration. Therefore, continuing the iterative processing using the image generation model based on the intermediate result image is using the intermediate result image obtained from the current iteration as the input for the next iteration, and continuing the iterative processing using the image generation model to achieve multiple iterations of processing on the reference image.

However, unlike the current method where the image generation model continues iterative processing directly based on the intermediate result image obtained after each iteration, the present disclosure only continues iterative processing using the image generation model based on the intermediate result image after that the intermediate result image is confirmed to meet the preset requirements, reducing the instances where the target image generated after multiple iterations does not meet the requirements.

Based on the above disclosure, in the process of performing multiple iterations of processing on the reference image using the image generation model based on the description information, the present disclosure determines whether the intermediate result image meets the preset requirements according to a preset detection strategy. Only if the intermediate result image meets the preset requirements will the iterative processing continue based on that intermediate result image using the image generation model. This reduces the instances where the target image generated by the image generation model does not meet the requirements, and naturally reduces the resource consumption caused by generating target images that do not meet the requirements.

In the present disclosure, there are different possible preset detection strategies. Some possible scenarios are described below as examples.

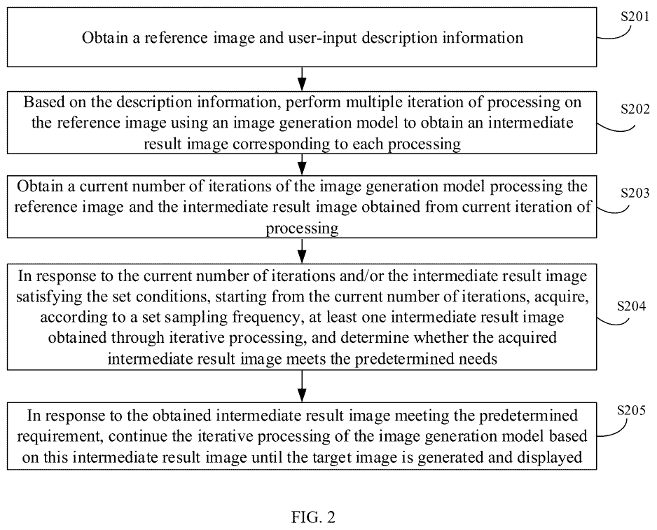

In some embodiments, the present disclosure can determine whether to perform a sampling inspection of the intermediate result image based on the current number of iterations performed by the image generation model and at least one of the intermediate result images obtained from the iterations. FIG. 2 is another flowchart of the image generation method provided by the present disclosure. The method in the present disclosure includes the following.

At S201, a reference image and user-input description information are obtained.

The description information is used to describe the image content of the target image to be generated.

At S202, based on the description information, multiple iterations of processing are performed on the reference image using an image generation model to obtain an intermediate result image corresponding to each processing.

At S203, a current number of iterations of the image generation model processing the reference image and an intermediate result image obtained from a current iteration of processing are obtained. The intermediate result image obtained from the current iteration of processing is also referred to as a “current intermediate result image.”

The current number of iterations refers to the cumulative number of iterative processing performed on the reference image by the image generation model, and is also referred to as a “current iteration number.” Since the iterative processing of the reference image using the image generation model includes processing the reference image and iteratively processing the intermediate result images generated based on the reference image, the current number of iterations represents the total number of iterative processing performed on the reference image and the intermediate result images of the reference image using the image generation model at the current time.

At S204, in response to the current number of iterations and/or the intermediate result image satisfying a set condition, starting from the current number of iterations, at least one intermediate result image obtained through iterative processing is acquired according to a set sampling frequency, and whether the acquired intermediate result image (also referred to as a “sampled intermediate result image”) meets the preset requirement is determined.

The current number of iterations and/or the intermediate result image satisfying the set conditions is the trigger condition for sampling the intermediate result images generated during the iterative process by the image generation model.

The set conditions can be set based on actual needs. The following describes the set conditions corresponding to the current number of iterations and the intermediate result image, respectively.

The current number of iterations satisfies the set conditions can be that the current number of iterations is within a set number of iterations range, or is not less than a set number of iterations. This set number of iterations and the number of iterations range can be set according to actual needs. For example, the set number of iterations or number of iterations range can be determined based on whether the intermediate result image obtained after the set number of iterations of processing the reference image meets the requirements in terms of correspondence with the description information, or whether the content of the intermediate result image can be initially recognized by the naked eye. For example, a tester can pre-analyze the intermediate result images obtained by the image generation model after different numbers of iterations on a test image to find the minimum number of iterations needed for the intermediate result image to contain the basic content outline expressed by the description information, and set this minimum number of iterations as the set number of iterations.

The intermediate result image satisfies the set conditions can include different situations. For example, the intermediate result image satisfies the set conditions can include: the degree of correspondence between the intermediate result image and the description information meets the requirements. For example, by identifying the semantic information expressed by the intermediate result image, if the degree of matching between the identified semantic information and the semantics expressed by the description information exceeds a set threshold, then it is determined that the degree of correspondence between the intermediate result image and the description information meets the requirements; or, the similarity between the image features of the intermediate result image and the features of the description information exceeds a set similarity threshold.

Another example of that the intermediate result image satisfies the set conditions is that the proportion of detailed areas in the intermediate result image exceeds a set ratio. If the intermediate result image contains the basic content outline described by the description information, then the intermediate result image will have some object edge lines. Therefore, by performing edge detection on the intermediate result image, the detailed area and flat area of the intermediate result image can be detected. If there are too few detailed areas, indicating that there is a lot of noise in the intermediate result image and the preliminary outline corresponding to the description information has not yet been formed.

Of course, intermediate result image satisfies the set conditions can include other situations, which can be set according to actual needs without limitation.

In practical applications, the present disclosure may only perform sampling of the intermediate result image when both the intermediate result image and the current number of iterations satisfy the set conditions. For example, if the current number of iterations is not less than the set number and the degree of correspondence between the intermediate result image and the description information meets the requirements, then starting from the current number of iterations, at least one intermediate result image obtained from the iterative processing is acquired at the set sampling frequency.

The set sampling frequency is the frequency at which the intermediate result images to be detected are sampled from the intermediate result images obtained from each iteration, starting from the current number of iterations.

The sampling frequency will vary depending on the type of image generation model or the total number of iterations needed by the image generation model to process the reference image.

In some embodiments, the sampling frequency can be a fixed frequency. For example, the sampling period corresponding to the sampling frequency can be 5 iterations or 10 iterations, etc. Correspondingly, starting from the current number of iterations, the intermediate result image obtained from the current iterative processing is acquired and detected every 5 or 10 iterations. The value of this fixed sampling frequency can be determined comprehensively based on the image generation model and the total number of iterations needed by the image generation model to process the reference image, without specific limitations.

For example, consider a scenario where intermediate result images are sampled every 5 iterations. Suppose the image generation model needs 30 iterations to produce the target image from the reference image, and the current iteration is the 5th. The intermediate result image from the 5th iteration is sampled and checked whether this intermediate image meets the preset requirements. Then, after the reference image is cumulatively processed 10 times using the image generation model, the intermediate image obtained after 10 iterations is acquired, and it is determined whether this intermediate image meets the preset requirements, and so on. The intermediate images obtained after 15, 20, and 25 iterations are also acquired, and it is determined whether these corresponding intermediate images meet the preset requirements.

In some embodiments, the sampling frequency can be non-fixed, meaning that the sampling frequency changes during the multiple iterations of processing the reference image using the image generation model. In this case, the sampling frequency can be determined based on at least one of the type of image generation model or the total number of iterations needed to process the reference image.

Specifically, considering that the intermediate result images obtained during the early iterations of processing the reference image using the image generation model determine the basic structure of the generated target image, such as the outline and content layout, if the intermediate result images obtained during the early iterations do not meet the requirements, then the probability of subsequent intermediate result images after multiple iterations also failing to meet the requirements will be relatively high. Then, in order to more reasonably sample the intermediate result images and reduce the resource consumption of image sampling, the present disclosure gradually reduces the sampling frequency as the number of iterations of the image generation model's iterative processing of the reference image increases.

For example, assuming sampling starts from the 6th iteration, then in the 6th to 12th iterations, the intermediate result image is sampled every two iterations. Correspondingly, the intermediate result images obtained from the 6th, 8th, 10th, and 12th iterations need to be obtained sequentially and checked to determine whether the intermediate result images meet the preset requirements. From the 12th to the 20th iteration, sampling occurs every 4 iterations, the intermediate result images obtained from the 16th and 20th iterations need to be obtained and checked for compliance with the preset requirements. For the 20th to 30th iterations (assuming the 30th iteration produces the target image), sampling occurs every 5 iterations, so the intermediate result image obtained from the 25th iteration is obtained and checked for compliance with the preset requirements.

In some embodiments, the sampling frequency can follow an exponentially decaying distribution during the iterative processing of the reference image by the image generation model.

When the sampling frequency is not fixed, the number of iterations to be sampled can be predetermined based on the sampling frequency, or based on the specific sampling frequency in real time, and there is no limitation on this.

At S205, in response to the obtained intermediate result image meeting the preset requirement, the iterative processing using the image generation model is continued based on this intermediate result image until the target image is generated and displayed.

It is understood that at S204, after each intermediate result image is obtained and determined to meet the preset requirements according to the set sampling frequency, S205 will be executed. If, according to the set sampling frequency, the intermediate result image obtained from the current iteration does not need to be checked for compliance with the preset requirement, the iterative processing using the image generation model can continue directly based on that intermediate result image.

In some embodiments, for the detection strategy, to adapt to the actual needs of different users, the user can set at least one sampling frequency for sampling the intermediate result images. For example, the electronic device can prompt the user to select an iteration range for sampling based on the total number of iterations needed by the image generation model to process the reference image, and allow the user to select at least one sampling iteration within that range to check the intermediate result images.

Based on the at least one sampling iteration set by the user, when the current iteration number of the image generation model processing the reference image is equal to the sampling iteration number, the intermediate result image obtained from the current processing is acquired, and it is determined whether the acquired intermediate result image meets the preset requirements.

For example, if sampling iterations set by the user include the 6th iteration, the 10th iteration, and the 18th iteration, then if the current iteration number is the 6th iteration, 10th iteration, or 18th iteration, the intermediate result image obtained from the current iteration processing can be acquired and checked to see if the intermediate result image meets the preset requirements.

In any embodiment of the present disclosure, the intermediate result image can be detected locally on the electronic device, or in a specific detection device. The following describes these two situations.

In some embodiments, the present disclosure can process the intermediate result image and send the intermediate result image to a detection device, and receive the detection result from the detection device.

The detection device is a device other than the electronic device. For example, if the electronic device is a terminal device, the detection device can be a cloud-based device node or other server, and there is no limitation on this.

The detection device detects whether the intermediate result image meets the preset requirements and returns the corresponding detection result to the electronic device. The detection result indicates whether the intermediate result image meets the preset requirements.

Processing the intermediate result image can include compressing the intermediate result image, or encrypting the intermediate result image to convert the intermediate result image into a hidden file. It is understood that the present disclosure sends only the intermediate result image obtained during the iterative processing to the detection device. Compared to sending the final target image generated by the image generation model to the detection device, the intermediate result image contains relatively less information, thus reducing the risk of data content leakage from the target image.

In some embodiments, the present disclosure can also use a local detection module to detect whether the intermediate result image meets the preset requirements. The detection module can be a detection model used to determine whether the intermediate result image meets the preset requirements. For example, the detection model can be the same as the image generation model, or a different model, and there is no limitation on this. The detection module can also be other processing modules, etc., and there is no limitation on this.

In any of the embodiments described above, there are multiple possible implementations for determining whether the intermediate result image meets the preset requirements. Several possible implementation methods are described below.

In some embodiments, it can be determined whether the semantic information expressed by the intermediate result image meets the preset requirements. For example, the detection module can be used to determine the semantic information of the intermediate result image and detect whether the semantic information meets the preset requirements, or a detection device can be used to determine whether the semantic information expressed by the intermediate result image meets the preset requirements, etc.

The semantic information expressed by the intermediate result image can reflect the content information of the intermediate result image. Therefore, it can be determined whether the intermediate result image contains sensitive information, violent content, or specified prohibited objects, etc. based on the semantic information expressed by the intermediate result image.

In some embodiments, the present disclosure can determine whether the image features of the intermediate result image meet the preset requirements. For example, the image features of the intermediate result image are determined. If the image features of the intermediate result image do not include the specified non-compliant image features, then it is determined that the image features of the intermediate result image meet the preset requirements.

The image features of the intermediate result image can characterize the information, content, or objects contained in the intermediate result image. Therefore,, it can be determined whether the intermediate image contains objects such as tools, text, or patterns that do not meet the requirements based on the image features of the intermediate result image.

For example, taking the case where the intermediate result image should not contain a knife as an example to determine whether the intermediate result image meets the preset requirements. By identifying the image features of the intermediate result image, it can be determined whether there are image features in the intermediate result image that match the features of a knife. If not, then it is confirmed that the intermediate result image meets the preset requirements.

It is understandable that, in practical applications, depending on the specific needs, the present disclosure can use either of the two implementation methods described above to determine whether the intermediate result image meets the preset requirements; or the two implementation methods can be combined to determine whether the intermediate result image meets the preset requirements. For example, only if the semantic information expressed by the intermediate result image meets the preset requirements, and the image features of the intermediate result image meet the preset requirements, is the intermediate result image determined to meet the preset requirements.

It is also understandable that, in any of the embodiments of the present disclosure, in order to reduce the occurrence of generated target images that do not meet the requirements, if the intermediate result image does not meet the preset requirements, the present disclosure can also use the image generation model to modify the intermediate result image to generate a target image that meets the preset requirements.

The purpose of modifying the intermediate result image is to obtain an intermediate result image that meets the requirements, and there can be multiple possible ways to specifically implement the modification of the intermediate result image.

For example, the intermediate result image can be discarded, and the reference image can be processed iteratively multiple times based on the description information using the image generation model to regenerate the image.

However, if the iterative processing of the reference image is terminated every time an intermediate result image is detected as not meeting the preset requirements, and the image generation model is used again to iteratively process the reference image based on the description information, this will inevitably increase the time needed to generate the target image needed by the user, and will also lead to a waste of resources consumed in generating the intermediate result image.

Based on the above, the present disclosure can also obtain at least one abnormal image region in the intermediate result image that does not meet the preset requirements, as well as the abnormal reason information why the abnormal image region does not meet the preset requirements. Further, the image generation model is used to modify the intermediate result image based on at least one abnormal image region in the intermediate result image and the corresponding abnormal reason information.

It is understandable that, in practical applications, the specific implementation method for determining whether the intermediate result image meets the preset requirements is different, and the specific reasons why the intermediate result image does not meet the preset requirements are also different, so the specific modification method for the intermediate result image can also be different in the present disclosure.

The following describes possible implementation methods for modifying the intermediate result image based on different implementation methods for determining whether the intermediate result image meets the preset requirements.

In some embodiments, where determining whether the intermediate result image meets the preset requirements involves determining whether the semantic information expressed by the intermediate result image meets the preset requirements, if the semantic information expressed by the intermediate result image is detected to not meet the preset requirements, the present disclosure can discard the intermediate result image and re-execute the iterative processing of the reference image using the image generation model based on the description information to regenerate the image.

The semantic information expressed by the intermediate result image reflects the overall content information of that intermediate result image. Therefore, the semantic information expressed by the intermediate result image does not meet the preset requirements, meaning that the overall content of the intermediate result image does not meet the requirements. In this case, the complexity of correcting the intermediate result image and regenerating the image is not significantly different. Therefore, the intermediate result image can be discarded, and the iterative processing of the reference image can be performed again using the image generation model based on the description information.

Due to the randomness of image processing mechanisms such as denoising in the image generation model, the intermediate result images output by the image generation model will differ even when the same image is input multiple times. After the non-compliance intermediate result image is discarded, the present disclosure re-uses the image generation model to iteratively process the reference image, thereby achieving the purpose of updating the intermediate result images generated in each iteration.

In some embodiments, where determining whether the intermediate result image meets the preset requirements includes determining whether the image features of the intermediate result image meet the preset requirements, if the image features of the intermediate result image are detected to not meet the preset requirements, the intermediate result image is modified using the image generation model based on the non-compliance image features in the intermediate result image.

Specifically, modifying the intermediate result image based on the non-compliance image features in the intermediate result image can be using the image generation model to modify the local area containing the non-compliance image features in the intermediate result image based on the non-compliance image features in the intermediate result image, and after that the modified intermediate result image meets the preset requirements is confirmed, continuing the iterative processing using the image generation model based on the modified intermediate result image.

Modifying the intermediate result image based on the non-compliance image features in the intermediate result image can also involve continuing the iterative processing using the image generation model based on the non-compliance image features in the intermediate result image and the intermediate result image, so that the image generation model corrects the non-compliance image features in the intermediate result image during the iterative processing and ultimately generates the target image.

In practical applications, the present disclosure can use one or two of the above implementation methods to correct the intermediate result image.

For ease of understanding, the following describes the specific implementation of correcting the intermediate result image, taking the detection of whether the semantic information and image features of the intermediate result image meet the requirements as an example.

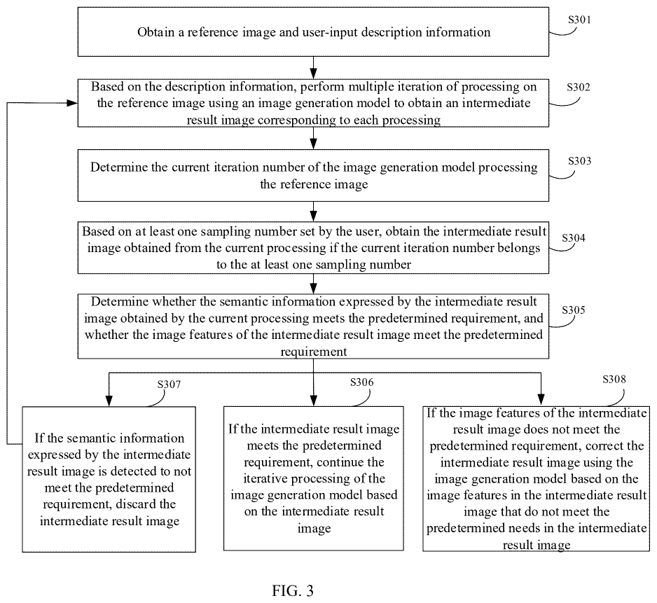

FIG. 3 is another flowchart of the image generation method consistent with the present disclosure. The method in the present disclosure includes the following.

At S301, a reference image and user-input description information are obtained.

The description information is used to describe the image content of the target image to be generated.

At S302, based on the description information, multiple iterations of processing are performed on the reference image using an image generation model to obtain an intermediate result image corresponding to each processing.

At S303, a current number of iterations of the image generation model processing the reference image.

At S304, based on at least one sampling number set by the user, the intermediate result image obtained from the current processing is obtained if the current number of iterations belongs to the at least one sampling number.

For ease of understanding, S303 and S304 are illustrated using a preset detection strategy as an example. However, if S303 and S304 are replaced with “obtaining the current iteration number of the image generation model processing the reference image, and the intermediate result image obtained from the current iterative processing, if the current iteration number and/or the intermediate result image meet the set conditions, starting from the current iteration number, obtaining at least one intermediate result image obtained from the iterative processing according to the set sampling frequency” or replaced with other preset detection strategies is also applicable to the embodiments of the present disclosure.

At S305, whether the semantic information expressed by the intermediate result image obtained by the current processing meets the preset requirement and whether an image feature of the intermediate result image meets the preset requirement are determined.

In the embodiments of the present disclosure, the example illustrates the case where it is needed to determine whether the semantic information expressed by the intermediate result image meets the preset requirements while also determining whether the image features of the intermediate result image meet the preset requirements.

In practical applications, whether the semantic information expressed by the intermediate result image meets the preset requirements can also be determined first. If the semantic information expressed by the intermediate result image meets the preset requirements, then determine whether the image features of the intermediate result image meet the preset requirements. If the semantic information expressed by the intermediate result image does not meet the preset requirements, then there is no need to determine whether the image features of the intermediate result image meet the preset requirements, and then proceed to execute S307.

At S306, if both the semantic information expressed by the intermediate result image and the image feature of the intermediate result image meet the preset requirement, the iterative processing using the image generation model is continued based on the intermediate result image until the target image is generated and displayed.

At S307, if the semantic information expressed by the intermediate result image is detected to not meet the preset requirement, the intermediate result image is discarded and the process returns to S302 to re-execute the iterative processing using the image generation model on the reference image.

At S308, if the image feature of the intermediate result image is detected to not meet the preset requirement, the intermediate result image is corrected using the image generation model based on the image feature in the intermediate result image that does not meet the preset requirement.

Reference can be made to the relevant descriptions above for the correction of the intermediate result image.

In some embodiments, if the image features of the intermediate result image are detected to not meet the preset requirements, at least one abnormal image region in the intermediate result image where the image features do not meet the preset requirements and the reason information for the image features in that abnormal image region do not meet the preset requirements can also be obtained. For example, the abnormal image region and the reason information for the image features in that abnormal image region can be determined through a detection module or detection device. Furthermore, the present disclosure can use the image generation model to correct the intermediate result image based on at least one abnormal image region in the intermediate result image and the abnormality information corresponding the abnormal image region.

For example, based on at least one abnormal image region in the intermediate result image and the corresponding abnormality information, the image generation model can be used to perform iterative processing on the intermediate result image to correct the intermediate result image during the iterative process and ultimately generate the target image.

In some embodiments, to ensure that the generated target image meets the preset requirements, the present disclosure can also iteratively process each abnormal image region in the intermediate result image using the image generation model, based on at least one abnormal image region in the intermediate result image and the corresponding abnormality information, until an intermediate result image that meets the preset requirements is obtained. Then, the process can return to S306 to continue the iterative processing using the image generation model based on the intermediate result image.

If the semantic information expressed by the intermediate result image does not meet the requirements, and the image features of the intermediate result image also do not meet the preset requirements, only S307 may be performed without S308 being performed.

It is understood that during the multiple iterative processing of the reference image using the image generation model, if there are many intermediate result images that do not meet the requirements, it is highly likely that the content described by the user's input description information is inappropriate, or that the user entered inappropriate description information. If the user's input description information contains content that does not meet the preset requirements, then there will be many intermediate result images that need to be corrected, leading to increased data processing resource consumption. Furthermore, it is possible that even after multiple correction processes, the target image may still not meet the preset requirements.

Therefore, to further reduce resource consumption and the risk of the target image not meeting the requirements, in any of the embodiments above, if it is determined that the currently sampled intermediate result image does not meet the preset requirements, the present disclosure can increment the number of abnormal processing times by one. This number of abnormal processing times represents the number of intermediate result images that need to be corrected, i.e., the number of corrections performed on the intermediate result image. Then, if the number of abnormal processing at the current time has not exceeded the set number, the present disclosure can use an image generation model to correct the intermediate result image. The specific correction method is as described in the previous embodiments and will not be repeated here. If the number of abnormal processing at the current time exceeds the set number, which indicates that there is an anomaly in the description information, and the image generation model can be controlled to end the iterative processing of the reference image.

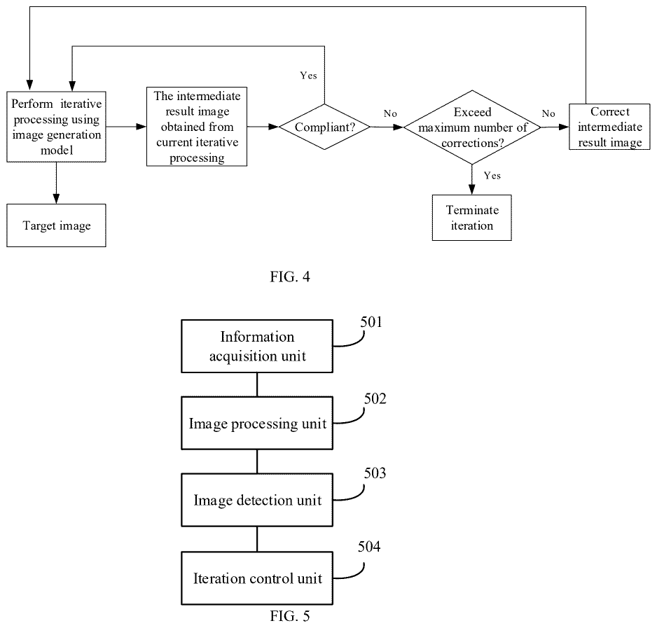

FIG. 4 shows a logical framework diagram of one implementation of the image generation method of the present disclosure.

As can be seen from FIG. 4, during the iterative processing of the reference image using the image generation model, if, based on the preset detection strategies mentioned earlier, it is determined that the current iteration number is the number of iterations at which intermediate result images need to be sampled, then the intermediate result image obtained from the current iterative processing is acquired.

By detecting whether the intermediate result image meets the preset requirements, it is determined whether the intermediate result image is compliant. If the intermediate result image is compliant, the iterative processing continues using the image processing model based on this intermediate result image. If the intermediate result image is not compliant, the number of corrections (i.e., the number of abnormal processing) is incremented by one, and whether the current number of corrections exceeds the set maximum number of corrections is checked. If the current number of corrections exceeds the set maximum number of corrections, the iterative processing of the reference image using the image processing model is terminated.

If the number of corrections does not exceed the set maximum number of corrections, the intermediate result image is corrected, and the iterative processing continues using the image processing model based on the corrected and compliant intermediate result image until the number of iterations of the image processing model reaches the target number of iterations, and the target image is output.

Of course, in practical applications, the present disclosure can also increment the number of abnormal processing by one after each intermediate result image is corrected.

It can be understood that if the number of abnormal processing at the current time exceeds the set number, the present disclosure can also output a description correction reminder, which is used to prompt the user to adjust the description information.

In any of the above embodiments of the present disclosure, after the target image generated by the image generation model is displayed, if the user believes that the target image has areas that do not meet the user's needs, the user can mark the non-compliance image areas in the target image and provide corresponding adjustment information for the marked image areas. Then, the present disclosure can also obtain the areas to be adjusted marked by the user in the target image and the adjustment information for these areas. Correspondingly, the present disclosure can utilize the image generation model to iteratively process the target image based on the marked area to be adjusted in the target image and the adjustment information of the area to be adjusted, to generate an adjusted target image. Then, the adjusted target image is output.

Corresponding to an image generation method of the present disclosure, the present disclosure also provides an image generation apparatus.

FIG. 5 shows a schematic diagram of a composition structure of an image generation apparatus consistent with the present disclosure. The apparatus includes the following.

An information acquisition unit 501, configured to obtain a reference image and user-input description information, where the description information is used to describe the image content of the target image to be generated.

An image processing unit 502, configured to process the reference image through a plurality of iterations using an image generation model based on the description information, to obtain intermediate result images corresponding to each processing.

An image detection unit 503, configured to determine whether the intermediate result image meets the preset requirements according to a preset detection strategy.

An iteration control unit 504, configured to, if the intermediate result image meets the preset requirements, continue to perform iterative processing using the image generation model based on the intermediate result image until the target image is generated and displayed.

In some embodiments, the image generation apparatus further includes the following.

An image correction unit, configured to, if the intermediate result image does not meet the preset requirements, correct the intermediate result image using the image generation model to generate a target image that meets the preset requirements.

In some embodiments, the image detection unit includes a first detection sub-unit, configured to obtain the current number of iterations of the image generation model processing the reference image, and the intermediate result image obtained from the current iterative processing. If the current number of iterations and/or the intermediate result image satisfy the set conditions, starting from the current number of iterations, obtain at least one intermediate result image obtained from the iterative processing according to a set sampling frequency, and determine whether the obtained intermediate result image meets the preset requirements.

In some embodiments, the image detection unit includes a second detection sub-unit, configured to, based on at least one sampling number set by the user, obtain the intermediate result image obtained from the current processing when the current number of iterations of the image generation model processing the reference image is the sampling number, and determine whether the obtained intermediate result image meets the preset requirements.

In some embodiments, the image detection unit, the first detection sub-unit, or the second detection sub-unit can determine whether the intermediate result image meets the preset requirements as below.

Processing the intermediate result image and sending the intermediate result image to a detection device, and receiving the detection result from the detection device, where the detection result indicates whether the intermediate result image meets the preset requirements.

As another example, using a local detection module to detect whether the intermediate result image meets the preset requirements.

In some embodiments, the image detection unit includes at least one of the following.

A first determination sub-unit, configured to determine whether the semantic information expressed by the intermediate result image meets the preset requirements according to a preset detection strategy.

A second determination sub-unit, configured to determine whether the image features of the intermediate result image meet the preset requirements according to a preset detection strategy.

The image correction unit includes at least one of the following.

A first correction sub-unit, configured to discard the intermediate result image if the semantic information expressed by the intermediate result image is detected to not meet the preset requirements, and return to perform the operation of the image processing unit to regenerate the image.

A second correction sub-unit, configured to correct the intermediate result image using the image generation model based on the image features in the intermediate result image that do not meet the preset requirements in the intermediate result image, if the image features of the intermediate result image are detected to not meet the preset requirements.

In some embodiments, the second correction sub-unit includes the following.

An anomaly determination sub-unit, configured to obtain at least one abnormal image region where the image features do not meet the preset requirements in the intermediate result image, and the anomaly reason information indicating why the image features of the abnormal image region do not meet the preset requirements, if the image features of the intermediate result image are detected to not meet the preset requirements.

A correction processing sub-unit, configured to correct the intermediate result image using the image generation model based on at least one abnormal image region in the intermediate result image and the corresponding anomaly reason information of the abnormal image region.

In some embodiments, the correction processing sub-unit includes a region correction sub-unit, configured to iteratively process each abnormal image region in the intermediate result image using the image generation model based on at least one abnormal image region in the intermediate result image and the corresponding anomaly reason information of the abnormal image region, until an intermediate result image that meets the preset requirements is obtained.

In some embodiments, the image correction unit includes the following.

A iteration number determination sub-unit, configured to increment the number of abnormal processing by one if the intermediate result image does not meet the preset requirements.

A correction triggering sub-unit, configured to correct the intermediate result image using the image generation model if the current number of abnormal processing has not exceeded the set number.

An iteration termination sub-unit, configured to control the image generation model to end the iterative processing of the reference image if the current number of abnormal processing exceeds the set number.

In some embodiments, the apparatus further includes:

A mark determination unit, configured to obtain the area to be adjusted marked by the user in the target image and the adjustment information of the area to be adjusted after the target image is displayed.

An image adjustment unit, configured to iteratively process the target image based on the area to be adjusted marked in the target image and the adjustment information of the area to be adjusted, using the image generation model to generate the adjusted target image.

An image output unit, configured to output the adjusted target image.

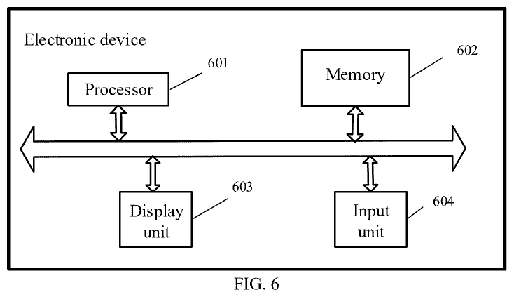

The present disclosure also provides an electronic device. As shown in FIG. 6, which shows a schematic diagram of a composition structure of the electronic device, the electronic device includes at least a processor 601 and a memory 602.

The processor 601 is used to execute the image generation method described in any of the above embodiments.

The memory 602 is used to store the programs needed for the processor to perform operations.

The electronic device may also include a display unit 603 and an input unit 604.

Of course, the electronic device may have more or fewer components than shown in FIG. 6, and there is no limitation on this.

The present disclosure also provides a computer program product, including computer-readable instructions, which, when executed on an electronic device, enable the electronic device to implement any of the image generation methods consistent with the present disclosure.

The present disclosure also provides a computer-readable storage medium, which carries one or more computer programs, which, when executed by an electronic device, enable the electronic device to implement any of the image generation methods consistent with the present disclosure embodiment.

It should also be noted that the apparatus embodiments described above are merely illustrative. The units described as separate components may or may not be physically separate, and the components shown as units may or may not be physical units, i.e., they may be located in one place or distributed across multiple network units. Some or all of the modules can be selected according to actual needs to achieve the purpose of present disclosure. Furthermore, in the drawings of the apparatus embodiments consistent with the present disclosure, the connection relationships between modules indicate that a communication connection, which can be implemented as one or more communication buses or signal lines.

Through the above description of the embodiments, those skilled in the art can clearly understand that the present disclosure can be implemented by means of software plus necessary general-purpose hardware, or present disclosure can also be implemented through dedicated hardware including dedicated integrated circuits, dedicated CPUs, dedicated memory, dedicated components, etc. Generally, functions performed by computer programs can be implemented with corresponding hardware, and the specific hardware structure used to implement the same function can also be diverse, such as analog circuits, digital circuits, or dedicated circuits. The technical solution of the present disclosure can be embodied in the form of a software product. This computer software product is stored in a readable storage medium, such as a computer floppy disk, USB flash drive, mobile hard drive, ROM, RAM, magnetic disk, or optical disc, and includes several instructions to enable a computer device (which can be a personal computer, training device, or network device, etc.) to perform the methods described in the different embodiments of the present disclosure.

In the above embodiments, all or part of the implementation can be achieved through software, hardware, firmware, or any combination thereof. When implemented using software, the present disclosure can be implemented entirely or partially in the form of a computer program product.

The computer program product includes one or more computer instructions. When the computer program instructions are loaded and executed on a computer, all or part of the processes or functions described in the embodiments of the present disclosure are generated. The computer can be a general-purpose computer, a special-purpose computer, a computer network, or other programmable device. The described computer instructions can be stored in a computer-readable storage medium, or transmitted from one computer-readable storage medium to another. For example, the computer instructions can be transmitted from one website, computer, training device, or data center to another website, computer, training device, or data center via wired (e.g., coaxial cable, fiber optic cable, digital subscriber line (DSL)) or wireless (e.g., infrared, radio, microwave, etc.) means. The computer-readable storage medium can be any available medium that a computer can store data on, or a data storage device such as a training device or data center that includes one or more integrated available media. The available media can be magnetic media (e.g., floppy disks, hard drives, magnetic tapes), optical media (e.g., DVDs), or semiconductor media (e.g., Solid State Drives (SSDs)), etc.

What is claimed is:

1. An image generation method comprising:
obtaining a reference image and user-input description information configured to describe image content of a target image to be generated;
performing iterative processing on the reference image using an image generation model based on the description information, to obtain one or more intermediate result images each corresponding to one iteration of the iterative processing;
determining whether the one or more intermediate result images meet a preset requirement according to a preset detection strategy; and
in response to the one or more intermediate result images meeting the preset requirement, continuing to perform the iterative processing using the image generation model based on the one or more intermediate result images until the target image is generated and output for display.

2. The method according to claim 1, wherein determining whether the one or more intermediate result images meet the preset requirement includes:
obtaining a current iteration number of the image generation model processing the reference image, and a current intermediate result image obtained from a current iteration of the iterative processing;
in response to at least one of the current iteration number or the current intermediate result image satisfying the predetermined condition, starting from the current iteration number, obtaining at least one sampled intermediate result image obtained from the iterative processing according to a set sampling frequency; and
determining whether the at least one sampled intermediate result image meets the preset requirement.

3. The method according to claim 1, wherein determining whether the one or more intermediate result images meet the preset requirement includes:
based on at least one sampling number set by user, in response to a current iteration number of the image generation model processing the reference image being one of the at least one sampling number, obtaining a current intermediate result image obtained from a current iteration of the iterative processing; and
determining whether the current intermediate result image meets the preset requirement.

4. The method according to claim 1, wherein determining whether the one or more intermediate result images meet the preset requirement includes:
after processing the one or more intermediate result images, sending the one or more intermediate result images to a detection device; and
receiving a detection result from the detection device, the detection result indicating whether the one or more intermediate result images meet the preset requirement.

5. The method according to claim 1, wherein determining whether the one or more intermediate result images meet the preset requirement includes:
detecting whether the one or more intermediate result images meet the preset requirement using a local detection module.

6. The method according to claim 1, further comprising:
in response to the one or more intermediate result images not meeting the preset requirement, correcting the one or more intermediate result images using the image generation model to generate the target image that meets the preset requirement.

7. The method according to claim 6, wherein determining whether the one or more intermediate result images meet the preset requirement includes determining whether at least one of semantic information expressed by the one or more intermediate result images or one or more image features of the one or more intermediate result images meet the preset requirement.

8. The method according to claim 7, wherein, in response to the one or more intermediate result images not meeting the preset requirement, correcting the one or more intermediate result images using the image generation model, includes:
in response to detecting that the semantic information does not meet the preset requirement, discarding the one or more intermediate result images and returning to perform iterative processing on the reference image using the image generation model based on the description information.

9. The method according to claim 7, wherein, in response to the one or more intermediate result images not meeting the preset requirement, correcting the one or more intermediate result images using the image generation model, includes:
in response to detecting that at least one image feature of the one or more image features does not meet the preset requirement, correcting the one or more intermediate result images using the image generation model based on the at least one image feature.

10. The method according to claim 9, wherein correcting the one or more intermediate result images using the image generation model based on the at least one image feature includes:
obtaining at least one abnormal image region, in the one or more intermediate result images, where the at least one image feature is located, and abnormal reason information for the at least one image feature to not meet the preset requirement; and
correcting the one or more intermediate result images using the image generation model based on the at least one abnormal image region and the abnormal reason information.

11. The method according to claim 10, wherein correcting the one or more intermediate result images using the image generation model based on the at least one abnormal image region and the abnormal reason information includes:
iteratively processing each of the at least one abnormal image region using the image generation model based on the at least one abnormal image region and the abnormal reason information, until an intermediate result image that meets the preset requirement is obtained.

12. The method according to claim 6, wherein correcting the one or more intermediate result images includes:
increment a number of abnormal processing by one;
in response to a current number of abnormal processing not exceeding a set number, correcting the one or more intermediate result images using the image generation model; and
in response to the current number of abnormal processing exceeding the set number, control the image generation model to terminate the iterative processing of the reference image.

13. The method according to claim 1, further comprising, after the target image is displayed:
obtaining an area to be adjusted marked by the user in the target image and adjustment information of the area to be adjusted;
based on the area to be adjusted and the adjustment information, iteratively processing the target image using the image generation model to generate an adjusted target image; and
outputting the adjusted target image.

14. An electronic device comprising:
a processor, and
a memory storing an application program that, when executed by the processor, causes the electronic device to:
obtain a reference image and user-input description information configured to describe image content of a target image to be generated;
perform iterative processing on the reference image using an image generation model based on the description information, to obtain one or more intermediate result images each corresponding to one iteration of the iterative processing;
determine whether the one or more intermediate result images meet a preset requirement according to a preset detection strategy; and
in response to the one or more intermediate result images meeting the preset requirement, continue to perform the iterative processing using the image generation model based on the one or more intermediate result images until the target image is generated and output for display.

15. The electronic device according to claim 14, wherein the application program when executed by the processor, further causes the electronic device to, when determining whether the one or more intermediate result images meet the preset requirement:
obtain a current iteration number of the image generation model processing the reference image, and a current intermediate result image obtained from a current iteration of the iterative processing;
in response to at least one of the current iteration number or the current intermediate result image satisfying the predetermined condition, starting from the current iteration number, obtain at least one sampled intermediate result image obtained from the iterative processing according to a set sampling frequency; and
determine whether the at least one sampled intermediate result image meets the preset requirement.

16. The electronic device according to claim 14, wherein the application program when executed by the processor, further causes the electronic device to, when determining whether the one or more intermediate result images meet the preset requirement:
based on at least one sampling number set by user, in response to a current iteration number of the image generation model processing the reference image being one of the at least one sampling number, obtain a current intermediate result image obtained from a current iteration of the iterative processing; and
determine whether the current intermediate result image meets the preset requirement.

17. The electronic device according to claim 14, wherein the application program when executed by the processor, further causes the electronic device to, when determining whether the one or more intermediate result images meet the preset requirement:
after processing the one or more intermediate result images, send the one or more intermediate result images to a detection device; and
receive a detection result from the detection device, the detection result indicating whether the one or more intermediate result images meet the preset requirement.

18. The electronic device according to claim 14, wherein the application program when executed by the processor, further causes the electronic device to, when determining whether the one or more intermediate result images meet the preset requirement:
detect whether the one or more intermediate result images meet the preset requirement using a local detection module.

19. The electronic device according to claim 14, wherein the application program when executed by the processor, further causes the electronic device to:
in response to the one or more intermediate result images not meeting the preset requirement, correct the one or more intermediate result images using the image generation model to generate the target image that meets the preset requirement.

20. A non-transitory computer-readable storage medium storing an application program that, when executed by a processor, causes an electronic device including the processor to:
obtain a reference image and user-input description information configured to describe image content of a target image to be generated;
perform iterative processing on the reference image using an image generation model based on the description information, to obtain one or more intermediate result images each corresponding to one iteration of the iterative processing;
determine whether the one or more intermediate result images meet a preset requirement according to a preset detection strategy; and
in response to the one or more intermediate result images meeting the preset requirement, continue to perform the iterative processing using the image generation model based on the one or more intermediate result images until the target image is generated and output for display.
